(19) United States
(12) Patent Application Publication
(10) Pub. No.: US 2002/0179092 A1
(43) Pub. Date: Dec. 5, 2002

(54) Medical examination apparatus, notably a magnetic resonance examination apparatus

(76) Inventors: Nico Michel Maria Swennen, Eindhoven (NL); Matheus Jakobus Maria Evers, Eindhoven (NL)

Correspondence Address: U.S Philips Corporation, 580 White Plains Road, Tarrytown, NY, 10591, US

(21) Appl. No.: 10/061,181

(22) Filed: Feb. 1, 2002

(30) Foreign Application Priority Data
Feb. 6, 2001 (EP) 01200416.4

(51) Int. Cl. A61G 15/00

(52) U.S. Cl. 128/845

(57) ABSTRACT

A medical examination apparatus (1) that includes a receiving space (2) and a mobile support (4) for an organism to be examined, the organism and/or the support (4) being connectable, via one or more signal transmission leads, to an evaluation unit of the medical examination apparatus (1); the examination apparatus is constructed in such a manner that at least a part of the connection is formed so as to be of a wireless type.

The invention relates to a medical examination apparatus as claimed in the introductory part of claim 1 that is provided with a mobile support for an organism to be examined.

An examination apparatus of the kind set forth can be used for the examination of human as well as animal organisms or parts of such organisms. An examination apparatus of the kind set forth includes a receiving space for accommodating the organism, which receiving space is situated in the axial inner space of an outer coil in the case of a magnetic resonance apparatus. When current is applied thereto, the coil generates a magnetic field that traverses the patient who is situated therein; such a field is capable of producing a variety of effects that are used for imaging purposes.

For example, a patient is introduced into the receiving space of the examination apparatus on a mobile bed that constitutes in general a support for the organism to be examined. Data concerning the organism to be examined, for example, a human, is transferred to an evaluation unit of the examination apparatus during, before and/or after the examination. Such data may include, for example, an identification, the breathing frequency, the pulse rate, the temperature or the blood pressure, but also an ECG or further patient data that can be used for adjustment of the parameters of the examination apparatus. Data can also be applied to the support, for example, in order to set the receiving coils on the support to a receiving mode. For example, an abrupt change of patient data during the examination may lead to the formation of an interrupt signal. It is also possible to adapt in advance the duration of the examination or other annoying factors to the condition of the patient concerned.

It is known to establish a data link between the evaluation unit and the carrier by way of a cable. However, notably in the case of frequent use this imposes the problem that a connector is then mechanically loaded to a significant extent. When a plug-type contact of this kind is associated with the receiving space, it will be loaded to a substantial degree in particular in situations involving a number of supports that can alternately be connected to the receiving space of the apparatus. Moreover, a considerable force is required so as to establish a plug-type connection. In individual cases this force may be even higher than 100 Newton. In order to ensure a reliable contact, the connectors must be manufactured with a very small tolerance of, for example, approximately 0.6 mm.

It is an object of the invention to improve this situation.

The problem is solved in accordance with the invention by means of a medical examination apparatus in conformity with the characterizing part of claim 1 as well as by means of a method in conformity with the characterizing part of claim 8. Further advantageous embodiments and versions are disclosed in the claims 2 to 7 and 9.

A mechanical connection for electrical contacting can be dispensed with because of the presence of the at least partly wireless connection between the support or the patient on the one side and the evaluation unit that is associated with the receiving space on the other side. Such a connection can be established without application of force and is also completely free from wear.

When an infrared transmission link is used, the further electronic equipment will not be interfered with. Infrared transmitters and receivers are easy to operate and require only a small amount of energy. The reliability of the connection is significantly enhanced because of the fact that it is not subject to wear. When at least the interface at the side of the support is rigidly connected to the support, it will be mechanically unsusceptible and also suitably protected against loss or damage.

When the interface at the side of the support and the interface that is associated with the receiving space are both mounted in a fixed position, the advantages will be realized for both sections of the apparatus. The infrared interfaces may be integrated in the respective housing of the support or of the apparatus section that encloses the receiving space, so that they are also unsusceptible to shocks. Influencing of the operation of the relevant interface is not to be expected either in case some apparatus section or other is displaced. When a support is aligned relative to the receiving space, the correct distance and the correct orientation of the two interfaces relative to one another are automatically ensured. Orientation markers for the alignment of the support can be provided for this purpose.

Further advantages and details will become apparent from an embodiment of the invention that will be described in detail hereinafter, by way of example, with reference to the drawing. In the drawing:

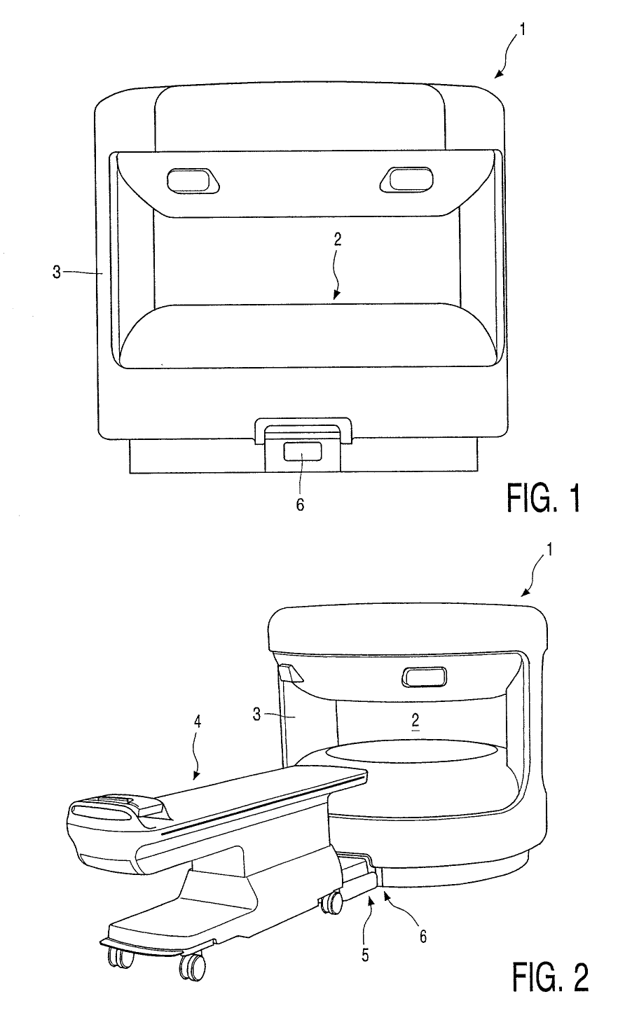

FIG. 1 shows the part of the medical examination apparatus that includes the receiving space,

FIG. 2 is a perspective view of the complete examination apparatus while the mobile support is in its aligned position in front of the receiving space,

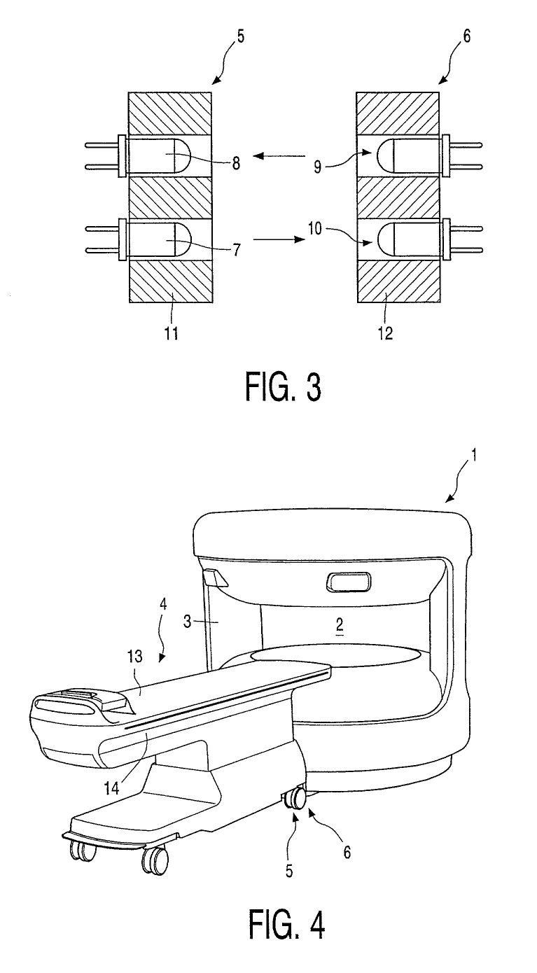

FIG. 3 is a diagrammatic representation of the two facing interfaces, and

FIG. 4 is a view similar to that of FIG. 2.

The embodiment in accordance with the invention constitutes an examination apparatus 1 in the form of a magnetic resonance tomography apparatus as shown in FIG. 1. This apparatus includes a receiving space 2 in which, for example, a patient to be examined or another organism can be introduced. The receiving space 2 is enclosed by a magnet system 3. The medical examination apparatus 1 includes a mobile support 4 that is provided for the organism to be examined and is constructed as a patient bed in the present embodiment.

The support 4 is provided with an infrared interface 5 that is rigidly connected to the support 4 in the present embodiment. Preferably, it is mounted behind collision strips in such a manner that it is protected also during displacement of the support 4. In the operating position of the support 4 and of the part of the examination apparatus 1 that includes the receiving space 2, the interface 5 of the support 4 is positioned so as to face an interface 6 that belongs to the receiving space 2 and to an evaluation unit that is associated therewith, so that a transfer of data can take place between the infrared interfaces 5 and 6. The support 4 is mechanically connected to the housing that accommodates the magnet system 3 and encloses the receiving space 2; this connection includes electrical contacts for the power supply of the support 4. Because of the fact that the power is much higher in comparison with the data transfer, such contacts are constructed so as to be mechanically stable and hence are not subject to wear.

Inside the mechanical housing that links the parts, the interfaces 5 and 6 may be built in so as to be fixed; they will then automatically occupy the transfer position upon docking. In this position the interfaces 5, 6 may be approximately 1 cm removed from one another. A larger distance between the interfaces 5 and 6, for example, a distance of several tens of centimeters, however, is also possible.

It is not absolutely necessary for the interfaces 5 and 6 to be built in so as to be fixed. It is also possible, for example, to establish a cable connection between the interface 6 and the part of the apparatus 1 that encloses the receiving space 2. The interface 6 should then be situated at the end of the cable that is remote from the receiving space 2. This interface could then be arranged, for example, so as to be detachable in a mount of the support 4 during the examination. After the examination, the interface 6 would then be detached from the mount and a further support 4 with a new patient could be introduced into a corresponding mount.

The rigidly built-in version of the two interfaces 5 and 6 offers the possibility of establishing the data link between the support 4 and the evaluation unit without any manual intervention. The support 4 can thus be even automatically displaced overall so as to be placed in its aligned position in front of the magnet system 3. Manual intervention can then be dispensed with.

In any case, the transfer of data takes place in a wireless manner, that is, via an infrared link in the present example; however, such a link is not absolutely necessary. A data transfer by way of electromagnetic waves of other frequency ranges, for example radio waves, is also possible. An ultrasound link is also a feasible option in this respect.

The infrared transmission can be realized, for example via LEDs 7, 8, 9, 10 (FIG. 3), the LEDs 7 and 8 being associated with the support 4. Data transmission is possible in both directions. The transmitters 7, 9 face the receivers 10, 8 of the respective oppositely situated interface. The transmitters (transmitter LEDs) 7, 9 as well as the receivers (receiver LEDs) 8, 10 are mechanically immobilized in a respective block 11, 12, so that the interfaces 5, 6 have a robust construction.

The amount of data transferred in such a device typically amounts to 100 MB. Such an infrared interface 5, 6 ensures fast serial data transmission. A wide variety of types of signal can be transferred. In addition to patient data, for example, image data that is acquired during the examination can also be applied to the support, so that subsequently this data can be derived from the support 4 for the patient.

For the examination first the support 4 is docked onto the part of the examination apparatus 1 that includes the receiving space 2, said docking operation ensuring that the interfaces 5, 6 are situated in the transfer position. A mechanically non-connected position of said parts is also feasible; for example, in that case an electrical contact for the power supply of the support 4 can be established via a flexible cable. The organism that rests on the upper surface 13, for example a bed, of the support 4 is introduced into the receiving space 2 while resting on said supporting surface that is movable along a separating plane 14 relative to the support 4, the organism being moved back onto the support 4 again after the examination. Subsequently, the electrical and data connection, and possibly also the mechanical connection between the parts, is detached.

1. A medical examination apparatus (1) that includes a receiving space (2) and a mobile support (4) for an organism to be examined, it being possible to connect the organism and/or the support (4) to an evaluation unit of the medical examination apparatus (1) via one or more signal transmission leads, characterized in that the connection is conceived to be at least partly wireless.

2. An examination apparatus as claimed in claim 1, characterized in that the wireless part of the connection is formed by an infrared transmission link (5, 6).

3. An examination apparatus as claimed in one of the claims 1 or 2, characterized in that the infrared transmission link (5, 6) includes at least one interface that is associated with the support (4) and one interface that is associated with the evaluation unit, at least the interface (5) that is situated at the side of the support being rigidly connected to the support (4).

4. An examination apparatus as claimed in claim 3, characterized in that the interface (6) at the side of the apparatus and the interface (5) at the side of the support are both built in so as to be stationary and are retained so as to face one another when the support (4) is in the aligned position relative to the receiving space of the examination apparatus.

5. An examination apparatus as claimed in one of the claims 1 to 3, characterized in that with the examination apparatus (1) there is associated a movable data lead that is connected to the examination apparatus at one end and is provided with an infrared interface (6) at its other end.

6. An examination apparatus as claimed in claim 5, characterized in that the infrared interface (6) of the data lead at the side of the apparatus can be detachably connected to a mount of the support (4).

7. An examination apparatus as claimed in claim 6, characterized in that the mount at the side of the support keeps the infrared interface (6) of the movable data lead at the side of the apparatus in a position that faces an infrared interface (5) at the side of the support.

8. A method of examining an organism in a medical examination apparatus, in which method the organism is arranged on a mobile support on which it is displaced relative to the examination apparatus, and in which a data transfer takes place between the organism and/or the support and the examination apparatus via a data lead, characterized in that prior to the introduction of the organism into the examination apparatus a partly wireless data connection is established between the organism and/or the support at the one side and the medical examination apparatus at the other side, the wireless part of the connection being discontinued after termination of the examination.

9. A method as claimed in claim 8, characterized in that a movable, flexible cable with an infrared position at one end is connected, by way of its end that is remote from the infrared interface, to the examination apparatus whereas its end that is provided with the infrared interface is connected, prior to the beginning of the examination, to a mount that is provided on the support and is detached from said mount after termination of the examination.
